(19) United States
(12) Patent Application Publication
(10) Pub. No.: US 2025/0147396 A1
(43) Pub. Date: May 8, 2025

(54) IMAGE PROJECTION APPARATUS

(71) Applicants: Mayu BANNO, KANAGAWA (JP); Kazuhiro FUJITA, TOKYO (JP); Sota HIRAHARA, KANAGAWA (JP); Yuto AKIBA, KANAGAWA (JP)

(72) Inventors: Mayu BANNO, KANAGAWA (JP); Kazuhiro FUJITA, TOKYO (JP); Sota HIRAHARA, KANAGAWA (JP); Yuto AKIBA, KANAGAWA (JP)

(21) Appl. No.: 18/935,654

(22) Filed: Nov. 4, 2024

(30) Foreign Application Priority Data
Nov. 6, 2023 (JP) 2023-189311
Jun. 13, 2024 (JP) 2024-095917

(51) Int. Cl. G03B 21/14; G03B 21/00; G03B 21/20

(52) U.S. Cl. CPC G03B 21/142; G03B 21/008; G03B 21/2013

(57) ABSTRACT

An image projection apparatus includes a light source; an image light generator to receive light emitted from the light source and generate image light; and a projection optical system to project the image light generated by the image light generator, onto a projection plane; and an optical component in the projection optical system. The projection optical system projects first image light having a first light energy onto a first focal position; and second image light having a second light energy larger than the first light energy of the first image light onto a second focal position. The projection plane is between the first focal position and the second focal position.

### CROSS-REFERENCE TO RELATED APPLICATIONS

This patent application is based on and claims priority pursuant to 35 U.S.C. § 119 (a) to Japanese Patent Application No. 2023-189311, filed on Nov. 6, 2023, and Japanese Patent Application No. 2024-095917, filed on Jun. 13, 2024, in the Japan Patent Office, the entire disclosure of which is hereby incorporated by reference herein.

### BACKGROUND

### Technical Field

The present disclosure relates to an image projection apparatus.

### Related Art

An image projection apparatus has been known that focuses light emitted from a light source on an image modulation element such as a digital micromirror device (DMD), and projects image light modulated by the image modulation element on a projection plane such as a screen.

When the temperature in the image projection apparatus increases due to operation, the optical characteristics of a projection optical system may change. Hence the focal position of image light projected on the projection plane may change, and image quality may decrease.

### SUMMARY

According to an embodiment of the present disclosure, an image projection apparatus includes a light source; an image light generator to receive light emitted from the light source and generate image light; and a projection optical system to project the image light generated by the image light generator, onto a projection plane; and an optical component in the projection optical system. The projection optical system projects first image light having a first light energy onto a first focal position; and second image light having a second light energy larger than the first light energy of the first image light onto a second focal position. The projection plane is between the first focal position and the second focal position.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a general arrangement diagram of an image projection apparatus according to a first embodiment of the disclosure;

FIG. 2 is a hardware configuration diagram of the image projection apparatus according to the first embodiment of the disclosure;

FIG. 3 is a diagram illustrating a method of adjusting a focal position according to the first embodiment of the disclosure;

FIG. 4 is a graph presenting an aspect of changes in focal positions according to the first embodiment of the disclosure;

FIG. 5 is a graph presenting a content of a second embodiment of the disclosure;

FIG. 6 is a graph presenting a content of a third embodiment of the disclosure;

FIG. 7 is a graph presenting a content of a fourth embodiment of the disclosure;

FIG. 8 is a graph presenting an aspect of changes in focal positions of respective image light having different magnitudes of light energies;

FIG. 9 is a graph presenting an example in which third image light having a focal position between two focal positions can be projected;

FIG. 10 is a view illustrating an example state in which a projection plane is divided in a matrix form including multiple areas;

FIG. 11 is a graph presenting an example of focal positions of first image light and second image light in each area of the projection plane;

FIG. 12 is a schematic diagram illustrating an example of a focus adjustment mechanism;

FIG. 13 is a flowchart presenting an example of focal position adjustment performed by the focus adjustment mechanism;

FIG. 14 is a diagram illustrating an example state before a focal position changes;

FIG. 15 is a diagram illustrating an example state after the focal position changes;

FIG. 16 is a graph presenting an example of displacement amounts of respective focal positions when two types of image light having different magnitudes of energies are projected;

FIG. 17 is a view illustrating an example arrangement of evaluation charts included in an image for focus adjustment;

FIG. 18A and FIG. 18B are views illustrating other examples of an image for focus adjustment;

FIG. 19 is a table presenting other examples of an evaluation chart; and

FIG. 20A, FIG. 20B, and FIG. 20C are views illustrating other examples of a background portion of an image for focus adjustment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

A method of adjusting the focal position using chromatic aberration of image light or distortion of a projection image has been proposed. With this method, image light with a specific wavelength (color) or a specific portion of a projection image is used to shift the focal position at the start of projection in advance in a direction opposite to a direction in which a change in position occurs. Accordingly, even when the focal position changes due to a temperature increase, the positional deviation is cancelled, thereby reducing a decrease in image quality.

However, in the method of adjusting the focal position using chromatic aberration or distortion, the adjustment range of the focal position is limited to the range of chromatic aberration or distortion. Thus, when the displacement width of the focal position exceeds the range of chromatic aberration or distortion, the focal position is not sufficiently adjusted in accordance with the change in focal position.

With the embodiment of the present disclosure, the focal position can be adjusted in accordance with the change in focal position.

### General Arrangement of Image Projection Apparatus

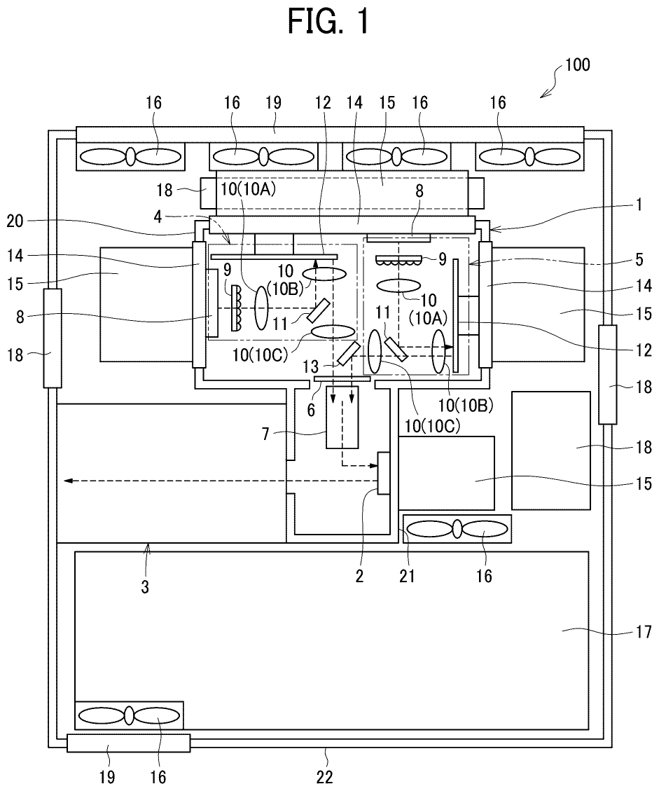

A general arrangement of an image projection apparatus 100 according to a first embodiment of the disclosure is described with reference to FIG. 1. In the drawings illustrating embodiments of the disclosure, components such as members and elements having identical or similar functions or shapes are given identical or similar reference signs as far as distinguishable, and redundant description is omitted.

As illustrated in FIG. 1, the image projection apparatus 100 according to the first embodiment of the disclosure includes an illumination device 1, an image light generator 2, and a projection optical system 3. The illumination device 1 irradiates the image light generator 2 with light. The image light generator 2 receives the light irradiated from the illumination device 1 and generates image light. Specifically, the image light generator 2 includes an image modulation element, such as a digital micromirror device (DMD) or a liquid crystal panel. When the illumination device 1 irradiates the image light generator 2 with light, the image modulation element modulates the light to generate image light. The projection optical system 3 projects the image light generated by the image light generator 2 on a projection plane such as a screen. The projection plane includes virtual projection planes, such as those provided as part of the specifications of the image projection apparatus 100.

The illumination device 1 includes a first light source unit 4, a second light source unit 5, a color wheel 6, a combining optical element 13, and a light uniformizing element 7.

Each of the light source units 4 and 5 includes a light source 8, a collimator lens 9, a condenser element 10, a dichroic mirror 11, and a wavelength conversion element 12.

For example, a laser diode (LD) is used as the light source 8. The collimator lens 9 is disposed at a position facing the light source 8. The collimator lens 9 converts excitation light emitted from the light source 8 into parallel light beams. The excitation light converted by the collimator lens 9 into the parallel light is focused by the condenser element 10. The condenser element 10 includes a first condenser element 10A disposed between the collimator lens 9 and the dichroic mirror 11, a second condenser element 10B disposed between the dichroic mirror 11 and the wavelength conversion element 12, and a third condenser element 10C disposed between the wavelength conversion element 12 and the color wheel 6 in a travel direction of light.

The dichroic mirror 11 is a wavelength selective mirror that reflects light with a specific wavelength and transmits light with the other wavelengths.

An example of the wavelength conversion element 12 is a disc-shaped fluorescent wheel. In the first embodiment of the disclosure, a case where a blue laser beam source is used as the light source 8 and a fluorescent wheel is used as the wavelength conversion element 12 is described as an example.

In each of the light source units 4 and 5, when light (blue light) is emitted from the light source 8, the light is focused by the first condenser element 10A, and the focused light is guided to the dichroic mirror 11. Then, light with the specific wavelength included in the guided light is reflected by the dichroic mirror 11, and the reflected light is focused by the second condenser element 10B. Hence a predetermined focus spot is generated on the fluorescent wheel serving as the wavelength conversion element 12.

The fluorescent wheel is a disc-shaped member that is rotatable at high speed by a driving motor. The fluorescent wheel has a fluorescent area that is a wavelength conversion area coated with a fluorescent material, and an excitation light reflecting area that is a wavelength non-conversion area that reflects the excitation light. As the fluorescent wheel rotates, the excitation light reflecting area and the fluorescent area are switched at the position of the focus spot on the fluorescent wheel.

When the excitation light reflecting area of the fluorescent wheel is located at the position of the focus spot, the light is output as blue light without wavelength conversion. In contrast, when the fluorescent area of the fluorescent wheel is located at the position of the focus spot, the light is wavelength-converted into yellow or yellow-green fluorescence and is output. The fluorescent wheel is not limited to the fluorescent wheel divided into the two areas of the excitation light reflecting area and the fluorescent area, and may have multiple fluorescent areas (for example, a fluorescent area that emits yellow light and a fluorescent area that emits green light) that convert light into light with wavelengths different from each other. The blue laser beam source is desirably a semiconductor blue laser beam source having oscillation wavelengths with a peak wavelength in a range from 440 nm to 465 nm.

The light beams reflected by the fluorescent wheel (wavelength conversion element 12) pass through the second condenser element 10B again, and then are focused by the third condenser element 10C. The focused light passes through the color wheel 6 and is incident on the light uniformizing element 7. In this case, the light focused by the third condenser element 10C of the first light source unit 4 travels straight, passes through the color wheel 6, and is guided to the light uniformizing element 7. In contrast, the light focused by the third condenser element 10C of the second light source unit 5 is reflected by a mirror serving as the combining optical element 13, the path of the light is changed in the same direction as the direction of the light of the first light source unit 4, and the light is guided to the color wheel 6 and the light uniformizing element 7. Alternatively, a prism may be used as the combining optical element 13 instead of the mirror.

The color wheel 6 transmits light from the light source units 4 and 5 while being rotated by a motor to divide the light into light of respective color components of red, blue, green, and yellow, and outputs the light to the light uniformizing element 7. Specifically, the color wheel 6 includes a transparent portion that transmits light of the blue component and the yellow component, a red filter that extracts light of the red component from yellow fluorescence, and a green filter that extracts light of the green component from green fluorescence while increasing the purity of the green component. When the light guided through the combining optical element 13 passes through the rotating color wheel 6, the light is divided into light of the respective color components and output to the light uniformizing element 7.

Examples of the light uniformizing element 7 include a light tunnel whose inside is hollow and whose inner surface is a combination of four mirrors, a rod integrator that is made of a transparent material such as glass and that forms a prism, and a fly eye lens. For example, when the light tunnel is used as the light uniformizing element 7, the aspect ratio of the light tunnel is set to be substantially equal to the aspect ratio of the image light generator 2, and the shape of the exit of the light tunnel is a shape projected on the surface of the image light generator 2, thereby efficiently providing illumination on the surface of the image light generator 2.

The light uniformized by the light uniformizing element 7 irradiates the image light generator 2, and the light is modulated by the image light generator 2. Thus, image light is generated. The image light generated by the image light generator 2 is enlarged by the projection optical system 3 and projected on the projection plane.

Next, a cooling mechanism of the image projection apparatus 100 according to the first embodiment of the disclosure is described.

As illustrated in FIG. 1, the image projection apparatus 100 according to the first embodiment of the disclosure includes multiple heat receiving members 14, multiple heat dissipation members 15, and multiple airflow generators 16 as a cooling mechanism that cools the inside of the image projection apparatus 100.

The multiple heat receiving members 14 are disposed in contact with the light sources 8 and the wavelength conversion elements 12 of the respective light source units 4 and 5. In the first embodiment of the disclosure, the three heat receiving members 14 are provided at three side surfaces included in a housing portion 20 of the illumination device 1.

The multiple heat dissipation members 15 are provided in contact with the respective heat receiving members 14 outside the housing portion 20 of the illumination device 1, and in contact with an outer surface of a housing portion 21 that houses the image light generator 2 and the light uniformizing element 7. Each of the heat dissipation members 15 is, for example, a heat sink including multiple fins. The fins may have any shape as long as the fins have at least multiple protrusions and depressions. Examples of the fins include plate fins, pin fins, and corrugated fins.

The multiple airflow generators 16 are provided near the heat dissipation members 15 and near an electronic substrate 17 in the image projection apparatus 100. Each of the airflow generators 16 is, for example, an axial fan or a sirocco fan. An exterior portion 22 of the image projection apparatus 100 is provided with multiple air supply ports 18 through which air is supplied into the image projection apparatus 100 and multiple air discharge ports 19 through which air is discharged from the image projection apparatus 100 by the driving of the airflow generators 16.

As described above, in the image projection apparatus 100 according to the first embodiment of the disclosure, since the multiple heat receiving members 14 are disposed in contact with the light sources 8 and the wavelength conversion elements 12, heat generated from the light sources 8 and the wavelength conversion elements 12 is transferred to the heat receiving members 14. The heat transferred to the heat receiving members 14 is transferred to the heat dissipation members 15 in contact with the heat receiving members 14, and is dissipated in the heat dissipation members 15. Thus, the light sources 8 and the wavelength conversion elements 12 can be cooled. Furthermore, airflows generated by the airflow generators 16 increase heat dissipation effect of the heat dissipation members 15, and cool the electronic substrate 17. The heat dissipated from the heat dissipation members 15 and other members is discharged through the air discharge ports 19 to the outside of the image projection apparatus 100 by the airflows generated in the image projection apparatus 100, thereby reducing a temperature increase in the image projection apparatus 100.

### Hardware Configuration

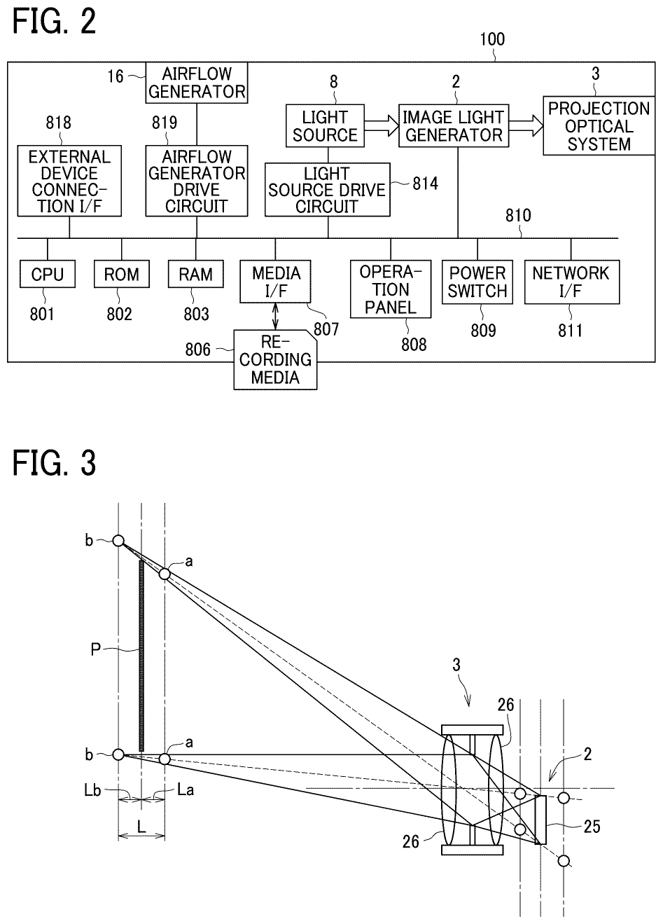

A hardware configuration of the image projection apparatus 100 according to the first embodiment of the disclosure is described below referring to FIG. 2.

As illustrated in FIG. 2, the image projection apparatus 100 includes a central processing unit (CPU) 801, a read only memory (ROM) 802, a random access memory (RAM) 803, a media interface (I/F) 807, an operation panel 808, a power switch 809, a bus line 810, a network interface (I/F) 811, a light source drive circuit 814, the light sources 8, the image light generator 2, the projection optical system 3, an external device connection interface (I/F) 818, an airflow generator drive circuit 819, and the airflow generators 16.

Among these components, the CPU 801 controls the entire operation of the image projection apparatus 100. The ROM 802 stores a program to boot the CPU 801. The RAM 803 is used as a work area for the CPU 801. The media I/F 807 controls reading or writing (storing) of data from or to a recording media 806 such as a flash memory.

The operation panel 808 includes, for example, various keys, buttons, and light emitting diodes (LEDs), and is used for a user to perform various operations other than turning on and off the power of the image projection apparatus 100. For example, the operation panel 808 receives an instruction operation, such as an operation of adjusting the size of a projection image, an operation of adjusting the color tone, a focus adjustment operation, or a keystone adjustment operation, and outputs the received operation content to the CPU 801.

The power switch 809 is for switching the power of the image projection apparatus 100 between on and off.

Examples of the bus line 810 include an address bus and a data bus for electrically connecting the components such as the CPU 801. The network I/F 811 is an interface for performing transmission and reception of data through a communication network such as the Internet. The external device connection I/F 818 is directly connected to a personal computer (PC) to exchange control signals and image data between the PC and the external device connection I/F 818.

The light source drive circuit 814 controls turning on and off of the light sources 8 under the control of the CPU 801.

When the light sources 8 are turned on under control of the light source drive circuit 814, the light sources 8 irradiate the image light generator 2 with light. The image light generator 2 generates image light corresponding to each color based on image data given via the external device connection I/F 818 or the like. The image light of each color generated by the image light generator 2 is projected on a projection plane via the projection optical system 3. As described above, the light source drive circuit 814, the light sources 8, the image light generator 2, and the projection optical system 3, as a whole, function as a projector (projection unit) that projects image light on a projection plane based on image data.

The airflow generator drive circuit 819 is connected to the CPU 801 and the airflow generators 16, to drive and stop driving the airflow generators 16 based on a control signal from the CPU 801.

When power is supplied from the power supply, the CPU 801 is activated in accordance with a control program stored in the ROM 802 in advance, gives a control signal to the light source drive circuit 814 to turn on the light sources 8, and gives a control signal to the airflow generator drive circuit 819 to drive the airflow generators 16. When the supply of power from the power circuit is started in the image projection apparatus 100, the image light generator 2 becomes a state available for displaying an image, and further power is supplied from the power circuit to various other components.

In the image projection apparatus 100, when the power switch 809 is turned off, a power off signal is transmitted from the power switch 809 to the CPU 801. When the CPU 801 detects the power off signal, the CPU 801 gives a control signal to the light source drive circuit 814 to turn off the light sources 8. Then, when a predetermined time elapses, the CPU 801 gives a control signal to the airflow generator drive circuit 819 to stop driving the airflow generators 16, ends the control process of the CPU 801, and finally gives an instruction to the power circuit to stop the supply of power.

### Change in Focal Position Due to Temperature Increase

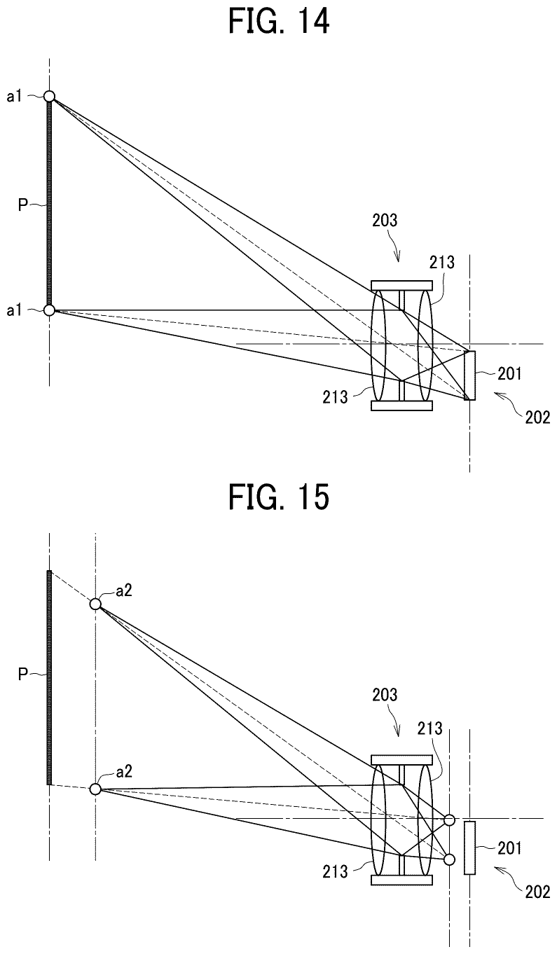

Next, a change in focal position due to a temperature increase is described referring to FIGS. 14 and 15.

FIG. 14 is a diagram illustrating an example state before a focal position changes. FIG. 15 is a diagram illustrating an example state after the focal position changes.

As illustrated in FIG. 14, when image light is emitted from an image modulation element 201 of an image light generator 202, the output image light passes through multiple lenses 213 included in a projection optical system 203, is enlarged, and is projected on a projection plane P such as a screen. At this time, a focal position a1 of the image light is adjusted to be aligned on the projection plane P, thereby displaying a good image.

However, when heat is generated from a heat generating member such as a light source due to operation of the image projection apparatus, the temperature in the image projection apparatus increases, and each member thermally expands, thereby changing the optical characteristics of, for example, the projection optical system 203. Consequently, as illustrated in FIG. 15, a focal position a2 of the image light changes to the near side with respect to the projection plane P (the side toward the projection optical system 203), and image quality of the image projected on the projection plane P decreases. In some cases, the focal position a2 of the image light may change to the far side with respect to the projection plane P (the side away from the projection optical system 203) in contrast to the example illustrated in FIG. 15, depending on an aspect of the change in optical characteristics.

Moreover, a change in focal position due to such a temperature increase tends to be more noticeable in a case of projecting image light having a large light energy such as a bright image than in a case of projecting image light having a small light energy such as a dark image.

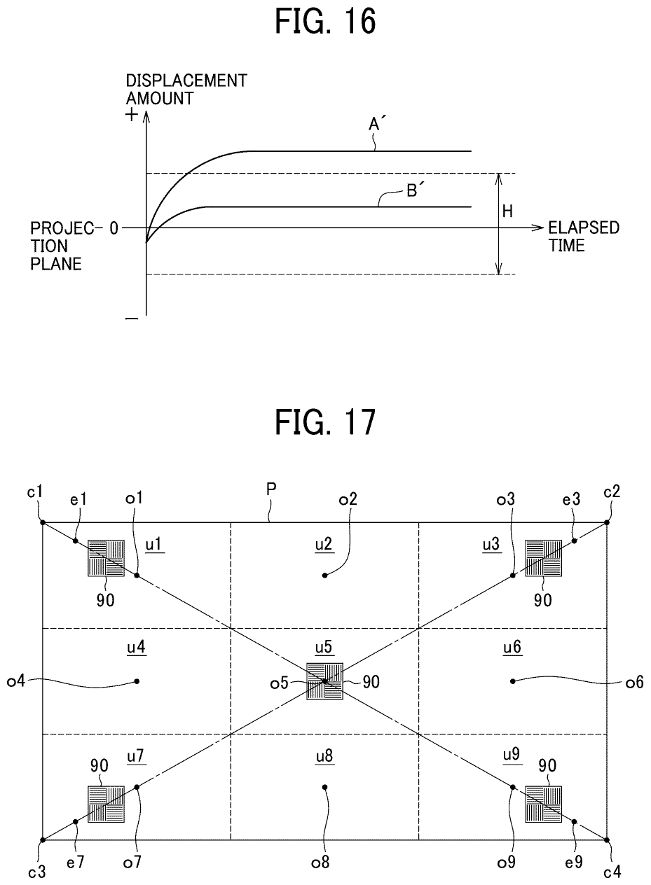

FIG. 16 is a graph presenting an example of displacement amounts of respective focal positions when two types of image light A′ and image light B′ having different magnitudes of energies are projected. In FIG. 16, the horizontal axis indicates the elapsed time since image light started being projected, and the vertical axis indicates the displacement amount of the focus when the position of the projection plane is “0”.

In this case, the plus side of the vertical axis indicates displacement to the near side, and the minus side indicates displacement to the far side.

As presented in FIG. 16, when the image light B′ having a small energy is projected, the focal position slightly changes to the near side over time; however, the displacement amount is small. Thus, the focal position is included in an allowable range H of image quality. In contrast, when the image light A′ having a large energy is projected, the focal position largely changes, the focal position goes out of the allowable range H of image quality, and the image quality may largely decrease.

To reduce a decrease in image quality due to a change in focal position, an embodiment of the disclosure proposes a method of adjusting a focal position as follows. The method of adjusting the focal position according to the embodiment of the disclosure is described below using the configuration according to the first embodiment of the disclosure as an example.

### Method of Adjusting Focal Position

FIG. 3 is a diagram illustrating the method of adjusting the focal position according to the first embodiment of the disclosure.

FIG. 3 illustrates a state in which image light output from an image modulation element 25 of the image light generator 2 passes through multiple lenses 26 of the projection optical system 3 and is projected on a projection plane P. The lenses 26 are an example of an optical component. A focal position a in FIG. 3 is a focal position when image light A having a large energy is projected. A focal position b in FIG. 3 is a focal position when image light B having a small energy is projected.

An image projection apparatus includes an optical component (e.g., the lenses 26) positioned in the projection optical system. The projection optical system projects first image light (e.g., the image light A) having a first light energy onto the first focal position, and second image light (e.g., the image light B) having a second light energy onto the second focal position. The projection plane is between the first focal position (e.g., the focal position a) and the second focal position (e.g., the focal position b).

In the embodiment of the disclosure, “image light A having a large energy” represents image light having a light energy larger than the light energy of image light B. That is, image light projected by the image projection apparatus according to the embodiment of the disclosure includes at least first image light having a predetermined light energy (image light B having a small energy) and second image light having a light energy larger than the light energy of the first image light (image light A having a large energy). The image light A having the large energy is image light having, for example, an average picture level (APL) larger than the APL of the image light B having the small energy. When image light to be projected is monochrome image light, the image light A having the large energy is image light having an area ratio of white image light larger than the area ratio of white image light of the image light B having the small energy.

In this case, the APL is obtained by calculating a total sum Ysum of brightness values Y of pixels and dividing the total sum Ysum by a total number N of the pixels, and can be calculated by APL Yave=Ysum/N. There is no particular limitation on the method of calculating the APL, and examples of the method of calculating the APL include a method of calculating the APL based on image information in the image projection apparatus, a method of calculating the APL using a PC or the like based on image data input to the image projection apparatus, and a method of measuring the brightness at each of positions of projected image light and averaging the brightness. The area ratio of white image light represents the ratio of pixels controlled to be white to the total number of pixels of the image light generator 2 when a monochrome image in which each pixel is one of white and black is projected. In this case, white is defined as a state controlled by the image light generator 2 so that light having the largest light intensity enters the projection optical system. Black is defined as a state controlled by the image light generator 2 so that light with the smallest light intensity enters the projection optical system.

As illustrated in FIG. 3, in the first embodiment of the disclosure, the position adjustment is performed so that the focal position b when the image light B having the small energy is projected and the focal position a when the image light A having the large energy is projected are arranged on sides opposite to each other with respect to the projection plane P. In other words, the focal positions a and b are adjusted so that the projection plane P is located between the focal position a when the image light A having the large energy is projected and the focal position b when the image light B having the small energy is projected.

The image projection apparatus includes circuitry (e.g., the circuit 801) to adjust the optical component (e.g., the lenses 26) so that at least a portion of a projection plane is between the first focal position and the second focal position.

In the first embodiment of the disclosure, the focal positions a and b arranged with the projection plane P interposed are focal positions when changes in the focal positions of the image light A and the image light B have become stable states after the image light A and the image light B start being projected. The “stable state” represents a state in which a change in focal position per unit time (rate of change) is 1/10 or less of a rate of change in a period from immediately after the projection of the first image light is changed to the projection of the second image light until one minute later ((focus movement distance)÷(60 seconds)). Alternatively, the “stable state” may be a state in which a change in temperature per unit time (rate of change) is 1/10 or less of a rate of change in a period from immediately after the projection of the first image light is changed to the projection of the second image light until one minute later ((temperature change amount)÷(60 seconds)).

The circuitry (e.g., the circuit 801) respectively adjusts the first focal position (e.g., the focal position b) and the second focal position (e.g., the focal position a) to a stabilized first focal position and a stabilized second focal position. The stabilized first focal position and the stabilized second focal position are positions where changes in the first focal position and the second focal position are stabilized after the projection optical system starts projecting the first image light and the second image light on the projection plane.

The circuitry (e.g., the circuit 801) respectively adjusts the first focal position and the second focal position to a stabilized first focal position and a stabilized second focal position. The stabilized first focal position and the stabilized second focal position are positions where a temperature change in the projection optical system is stabilized after the projection optical system starts projecting the first image light and the second image light on the projection plane.

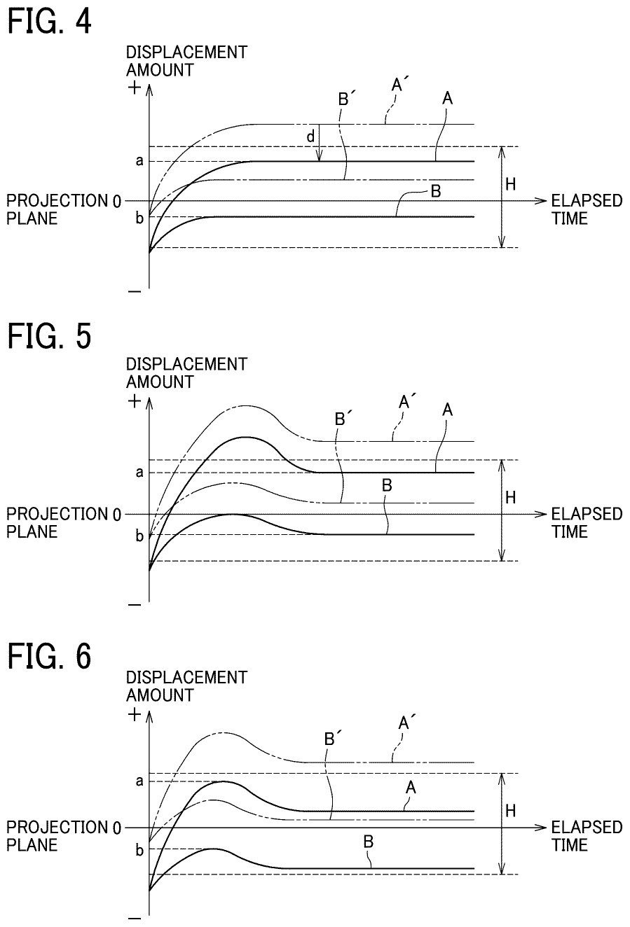

As described above, in the first embodiment of the disclosure, since the focal positions a and b arranged with the projection plane P interposed are determined as the focal positions when the changes in focal positions have become the stable states, as presented in FIG. 4, the focal positions a and b in the stable states can be included in the allowable range H of image quality. That is, in the first embodiment of the disclosure, as compared to a comparative example indicated by two-dot chain lines in FIG. 4, the focal positions are shifted in advance to a side opposite to a focus displacement direction (the minus side of the Y-axis). Hence both the focal positions a and b in the stable states can be included in the allowable range H of image quality. In the case of the comparative example, since respective focal positions in stable states during projection of image light A′ and image light B′ are located on the plus side of the Y-axis with respect to the position of the projection plane P, in particular, the focal position in the stable state when the image light A′ having a large energy is projected is outside the allowable range H of image quality. In contrast, in the first embodiment of the disclosure, the focal position b in the stable state when the image light B having the small energy is projected and the focal position a in the stable state when the image light A having the large energy is projected are arranged with the projection plane P interposed. Hence both the focal positions a and b in the stable states can be included in the allowable range H of image quality. A shift amount d of the focal position may be appropriately set in accordance with the amount of deviation between the focal position in the stable state when the focal position is not shifted (in the case of the comparative example) and the allowable range H of image quality, and the width of the allowable range H of image quality.

In general, initial setting such as an input switching operation by a user or the like is often performed for a while after image light starts being projected. Hence it is desirable to give priority to image quality after the focal position transitions to the stable state rather than image quality immediately after the start of the projection. Thus, in the first embodiment of the disclosure, the focal positions a and b in the stable states are adjusted to be arranged with the projection plane P interposed. Accordingly, the image quality when the initial setting by the user or the like has been completed and the focal positions a and b have become the stable states can be improved.

In the first embodiment of the disclosure, when the focal position is adjusted, chromatic aberration of image light or distortion of a projection image is not used. Hence the adjustment range is not limited to the range of chromatic aberration or distortion. Thus, the focal position can be adjusted in accordance with a change in focal position.

Accordingly, with the adjustment method according to the first embodiment of the disclosure, even when the amount of deviation of the focal position exceeds the range of chromatic aberration or distortion, the focal position can be adjusted in accordance with the change in focal position, and the image quality can be improved.

The distances between the respective focal positions a and b and the projection plane P can be appropriately set. For example, referring to FIG. 3, distances La and Lb from the projection plane P to the respective focal positions a and b may be set to ½ of a distance L between the focal positions a and b (L/2). In this case, the image quality when the focal position has become the stable state in the case where the image light A having the large energy is projected can be almost equal to the image quality when the focal position has become the stable state in the case where the image light B having the small energy is projected. To improve the image quality at the focal position a when the image light A having the large energy is projected, the distance La between the focal position a and the projection plane P is desirably smaller than L/2. In contrast, to improve the image quality at the focal position b when the image light B having the small energy is projected, the distance Lb between the focal position b and the projection plane P is desirably smaller than L/2.

As described above, the distances La and Lb between the projection plane P and the respective focal positions a and b can be appropriately changed. However, when the distances La and Lb between the projection plane P and the respective focal positions a and b excessively increase, a decrease in image quality at the focal position having a large distance may be noticeable. Thus, it is desirable to set the distances La and Lb between the projection plane P and the respective focal positions a and b within a range from ⅓ to ⅔ of the distance L between the focal positions a and b (L/3≤La, Lb≤2L/3).

Next, other embodiments of the disclosure are described. Hereinafter, portions different from those in the first embodiment of the disclosure are mainly described, and the description of the identical or similar portions is appropriately omitted.

FIG. 5 is a graph presenting a content of a second embodiment of the disclosure. Specifically, in FIG. 5, solid lines A and B indicate an aspect of changes in respective focal positions when a method of adjusting a focal position according to the second embodiment of the disclosure is applied, and two-dot chain lines A′ and B′ indicate an aspect of changes in respective focal positions in a comparative example to which the second embodiment of the disclosure is not applied. The solid line A and the two-dot chain line A′ indicate an aspect of changes in respective focal positions when image light A and image light A′ having large energies are projected. The solid line B and the two-dot chain line B′ indicate an aspect of changes in respective focal positions when image light B and image light B′ having small energies are projected. The contents indicated by the solid lines A and B and the two-dot chain lines A′ and B′ are applied in respective drawings of other embodiments described later.

As presented in FIG. 5, in this case, when the image light A, the image light B, the image light A′, and the image light B′ are projected, the focal positions of the respective image light temporarily largely change, then the changes in focal positions are reduced, and then the states become stable states. As described above, the focal position may largely change after the image light starts being projected, and then become the stable state.

In this case, in the comparative example, when the image light A′ having the large energy is projected, the focal position largely changes. Hence the focal position is outside the allowable range H of image quality. Even when the focal position thereafter has become the stable state, the focal position is outside the allowable range H. In contrast, in the second embodiment of the disclosure, even when the image light A having the large energy is projected, the focal position in the stable state is included in the allowable range H of image quality.

As described above, while the focal position in the stable state is included in the allowable range H of image quality in the second embodiment of the disclosure, the focal position is outside the allowable range H of image quality when the change in focal position is maximum. However, since initial setting is often performed by the user or the like for a while after the projection is started, it is desirable in many cases to give priority to the image quality after the focal position transitions to the stable state rather than the image quality until the change in focal position becomes maximum after the projection is started. Thus, in the second embodiment of the disclosure, the focal position in the stable state is included in the allowable range H to give priority to the image quality after the focal position transitions to the stable state.

In the second embodiment of the disclosure, to ensure the image quality in the stable state in both the case where the image light A having the large energy is projected and the case where the image light B having the small energy is projected, the focal positions a and b in the stable states in the respective cases are arranged with the projection plane P interposed. Thus, compared to the comparative example indicated by the two-dot chain lines in FIG. 5, the focal positions can be shifted in advance to the side opposite to the focus displacement direction (the minus side of the Y-axis). Each of the focal positions a and b in the stable states can be included in the allowable range H of image quality.

FIG. 6 is a graph presenting a content of a third embodiment of the disclosure.

The third embodiment of the disclosure presented in FIG. 6 provides an aspect in which a focal position temporarily largely changes similarly to the second embodiment of the disclosure presented in FIG. 5. In this case, however, focal positions a and b when changes are maximum are included in an allowable range H of image quality.

Depending on the configuration of the image projection apparatus, it may take a long time from when the focal position is most largely displaced to when the focal position transitions to the stable state. In such a case, a decrease in image quality until the focal position becomes the stable state may impose a stress on the user. Thus, in the third embodiment of the disclosure, to properly ensure the image quality when the focal position has the maximum displacement, focal positions a and b when changes have become maximum after image light A and image light B start being projected are adjusted to be arranged on the sides opposite to each other with respect to the projection plane P. Thus, the focal positions a and b having the maximum displacements are included in the allowable range H of image quality, thereby improving the image quality when the focal positions have the maximum displacements.

The circuitry (e.g., the circuit 801) respectively adjusts the first focal position and the second focal position to a maximized first focal position and a maximized second focal position where changes in the first focal position and the second focal position are maximized after the projection optical system starts projecting the first image light and the second image light on the projection plane.

FIG. 7 is a graph presenting a content of a fourth embodiment of the disclosure.

In the fourth embodiment of the disclosure presented in FIG. 7, after image light A having a large energy starts being projected, the image light to be projected is switched to image light B having a small energy, and projection is performed. In this case, the focal position temporarily largely changes due to the projection of the image light A having the large energy, and then the state transitions to the stable state. Then, when the image light to be projected is switched to the image light B having the small energy, the focal position is largely displaced in the direction opposite to the direction of the displacement during the projection of the image light A having the large energy, and then the state transitions to the stable state. Since the image quality may largely decrease when the change in focal position becomes maximum, the image quality is desirably included in the allowable range when the change in focal position becomes maximum if possible.

Thus, in the fourth embodiment of the disclosure, focal positions a and b when the changes have become maximum in the case where the image light A and the image light B are projected are arranged with the projection plane P interposed. Thus, the focal positions a and b with the maximum displacements can be included in the allowable range H of image quality, thereby improving the image quality.

Relationship between Focal Position and Allowable Range of Image Quality

In each of the above-described embodiments, the focal positions in the case where the two types of image light, that is, the image light A having the large energy and the image light B having the small energy are projected have been described as an example. However, in general, the image projection apparatus can project various types of image light having different magnitudes of light energies without limited to the two types of image light. The aspect of changes in focal positions of these image light varies depending on the magnitude of the light energy of each image light.

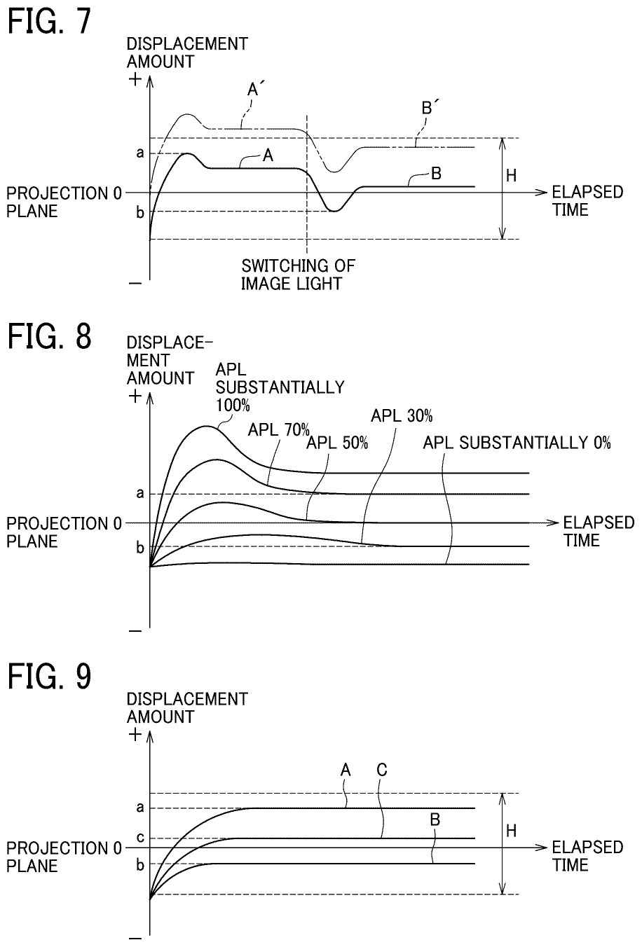

FIG. 8 is a graph presenting an aspect of changes in focal positions of respective image light having different magnitudes of light energies.

In this case, the magnitude of the light energy of each image light is determined by an APL. Specifically, FIG. 8 presents an aspect of changes in focal positions when the APLs of the respective image light are substantially 0%, 30%, 50%, 70%, and substantially 100% and the respective image light are projected. The reason why the APLs are “substantially 0%” and “substantially 100%” instead of “0%” and “100%” is that when the APL is completely “0%” or “100%”, the entire image is a black image or a white image and the focal position cannot be adjusted.

As presented in FIG. 8, the focal position hardly changes when the APL is substantially 0%; however, as the APL becomes 30%, 50%, 70%, and substantially 100%, the focal position largely changes, and the time until the displacement of the focal position becomes maximum and the time until the state transitions to the stable state decrease.

In order to properly ensure the image quality, in particular, the focal position after the state becomes the stable state is desirably included in the allowable range H of image quality. Ideally, the focal positions in the stable states of all the image light having the APLs from 0% to 100% are desirably included in the allowable range H of image quality; however, it is actually difficult to satisfy such a condition. Accordingly, it is desirable to determine the range of the APLs of the image light whose focal positions are included in the allowable range

H of image quality, in accordance with an aspect of actual use.

When the aspect of actual use is considered, it is found that image light having an APL of 30% to 70% is typically used frequently. Hence, the focal position in the stable state when the image light having the APL from at least 30% to 70% is projected is desirably included in the allowable range H of image quality. Accordingly, as presented in FIG. 8, the focal position b in the stable state of image light having an APL of 30% and the focal position a in the stable state of image light having an APL of 70% are desirably adjusted with the projection plane P interposed. Alternatively, the focal positions may be arranged with the projection plane P interposed so that the focal position having the maximum displacement amount of the image light having the APL of 30% and the focal position having the maximum displacement amount of the image light having the APL of 70% both are included in the allowable range H of image quality. The two types of image light whose focal positions a and b are adjusted are not limited to image light whose APLs are 30% and 70%, and can be desirably set as long as APLs are 30% or less and 70% or more.

The two types of image light are not limited to the first image light having the small energy with the APL of 30% or less and the second image light having the large energy with the APL of 70% or more. The way of selecting the two types of image light can be appropriately changed in accordance with demanded image quality or the like.

For example, among the two types of image light having different magnitudes of light energies, the first image light may be image light having a light energy smaller than 50% of light having the maximum energy that the light source can emit, and the second image light may be image light having a light energy larger than 50% of the light having the maximum energy that the light source can emit.

Alternatively, the first image light may be image light in which an image of a black background includes an evaluation chart for evaluating image quality or the focal position in an emission mode of the darkest light that the light source can emit. The second image light may be image light in which an image of a white background includes an evaluation chart for evaluating image quality or the focal position in an output mode of the brightest light that the light source can output.

Still alternatively, the first image light may be image light having a light energy that is 1/10 or less of the light energy of the second image light.

### Unit of Adjusting Focal Position

A unit of adjusting the focal position is described next.

Examples of the unit of adjusting the focal position include a unit of changing the position of one or some lenses 26 (see FIG. 3) included in the projection optical system 3 to change the distance between the lenses 26, and a unit of changing the distance between a lens 26 and the image modulation element 25. The examples of the unit of adjusting the focal position also include a unit of changing the positions of all the lenses 26 of the projection optical system 3, and a unit of, while keeping the positions of the lenses 26 at both ends unchanged, changing the positions of the other lenses 26.

When the image modulation element 25 is secured to a housing and the projection optical system 3 is attached to the housing or a bracket coupled to the housing, a shim member may be interposed between the bracket and the projection optical system 3, or between the bracket and the housing to adjust the distance between the projection optical system 3 and the image modulation element 25. When the shift amount of the focal position is determined in advance, the focal position can be easily adjusted by interposing the shim member.

Alternatively, in order to adjust the focal position, the distance between the bracket and the projection optical system 3 or the distance between the bracket and the housing may be changed. For example, the distance between the bracket and the projection optical system 3 or between the bracket and the housing can be changed by changing the pressing amount of a spring member held between the bracket and the projection optical system 3 or between the bracket and the housing. In this case, the shift amount of the focal position can be adjusted by changing the rotation angle of a screw that adjusts the pressing amount of the spring member, and hence finer adjustment can be performed than the unit using the shim member.

Still alternatively, when the image modulation element 25 is movable, the image modulation element 25 may be moved to change the distance between the projection optical system 3 and the image modulation element 25. In this case, an object to be moved is the image modulation element 25 that is lighter than the projection optical system 3, and hence the adjustment operation can be easily performed.

The examples of the unit of adjusting the focal position further include a method of deforming a member interposed between the image modulation element 25 and the projection optical system 3 using heat. For example, a housing interposed between the image modulation element 25 and the projection optical system 3 may be warmed by a heater and thermally expanded to change the distance between the image modulation element 25 and the projection optical system 3. Using the heater can quantitatively thermally expand the housing, and hence can precisely adjust the focal position.

Instead of the heater, the housing or the like may be warmed using heat generated in the image projection apparatus. For example, heat is generated when the image modulation element 25 generates image light and when the image light irradiates a member (for example, a light cutoff plate) other than the projection optical system 3. Hence the heat may be used as heat for warming the housing or the like. Alternatively, heat generated from the light source may be used as the heat for warming the housing or the like. These methods can reduce power consumption as compared to the case where the heater is used, thereby saving energy. Furthermore, by controlling the amount of thermal expansion of the housing or the like using a temperature sensor or a strain gauge, the focal position can be adjusted with higher precision.

As presented in FIG. 9, to easily adjust the focal position, third image light C having a focal position c between the two focal positions a and b to be adjusted may be projected. For example, in monochrome image light, when image light having a proportion of black of 90% or more is first image light and image light having a proportion of white of 90% or more is second image light, the third image light is image light having a proportion of white or black in a range from 35% to 65%. When the first image light is image light having an average brightness of 30% and the second image light is image light having an average brightness of 70%, the third image light may be image light having an average brightness in a range from 40% to 70%.

The projection optical system projects third image light having a third focal position between the first focal position and the second focal position. The third focal position is on the projection plane.

When the user or the like projects such third image light and performs adjustment so that the focal position c at that time is aligned with the projection plane P, the focal position a of the image light having the light energy larger than the light energy of the third image light and the focal position b of the image light having the light energy smaller than the light energy of the third image light are adjusted to be located on the sides opposite to each other with respect to the projection plane P. In the example presented in FIG. 9, the focal position c of the third image light C adjusted to be aligned with the projection plane P is the focal position in the stable state; however, the focal position c can be desirably set.

Alternatively, the third image light C may be set to image light having an APL of about 50%, and the APL of the third image light C may be changed in accordance with the content or mode of the image light to be projected.

For example, since image light when a presentation material or the like is projected often has a relatively high APL, the APL of the third image light C may be changed to 70% in a presentation mode. In contrast, since image light when an image of a movie or the like is projected often has a relatively low APL, the APL of the third image light C may be changed to 30% in a movie mode or a theater mode. As described above, the APL of the third image light C is desirably changed in accordance with the projection mode of the image projection apparatus, thereby ensuring high image quality.

The third image light may be image light including an evaluation chart for evaluating the image quality or the focal position. In this case, the user or the like may adjust the focal position to improve the image quality of the evaluation chart while visually checking the evaluation chart, and hence the focal position is easily adjusted. The evaluation chart may include characters such as alphabets or numerals, signs, or figures, and may be any image as long as the image quality can be visually checked.

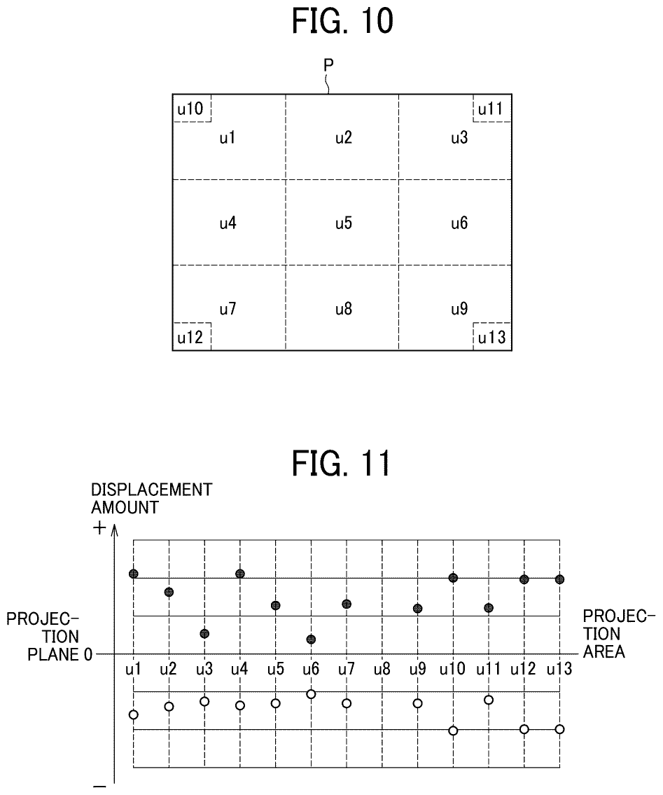

The evaluation chart may be any chart that is projected on at least one area among multiple areas u1 to u13 obtained by dividing a projection plane P in a matrix form as illustrated in FIG. 10. By projecting the evaluation chart on any area of the projection plane P and adjusting the focal position of the evaluation chart to be aligned with the projection area, the focal positions a and b of the first image light and the second image light can be arranged, for example, as presented in FIG. 11.

FIG. 11 presents the focal positions a and b of the first image light and the second image light for each of the multiple areas u1 to u13 obtained by dividing the projection plane P. A white circle in FIG. 11 indicates the focal position b of the first image light having the small light energy, and a black circle in FIG. 11 indicates the focal position a of the second image light having the large light energy. In the area u8, the focal positions a and b could not be measured, and hence a white circle and a black circle are not indicated. As described above, using the evaluation chart included in the third image light C can adjust the focal positions a and b of the first image light and the second image light to be located on the sides opposite to each other with respect to the projection plane P.

When the projection plane P is large or slightly curved, it may fail to align the focal positions of the evaluation chart in any of all the areas u1 to u13 of the projection plane P. In such a case, for example, the focal positions of the evaluation chart may be aligned in the center area u5, and then the focal positions of the evaluation chart may be aligned in, for example, each of the upper areas u1, u2, u3, u10, and u11, using a mechanism that changes the size of the projection image.

### Focus Adjustment Mechanism

Next, a configuration of a focus adjustment mechanism included in the image projection apparatus according to an embodiment of the disclosure is described.

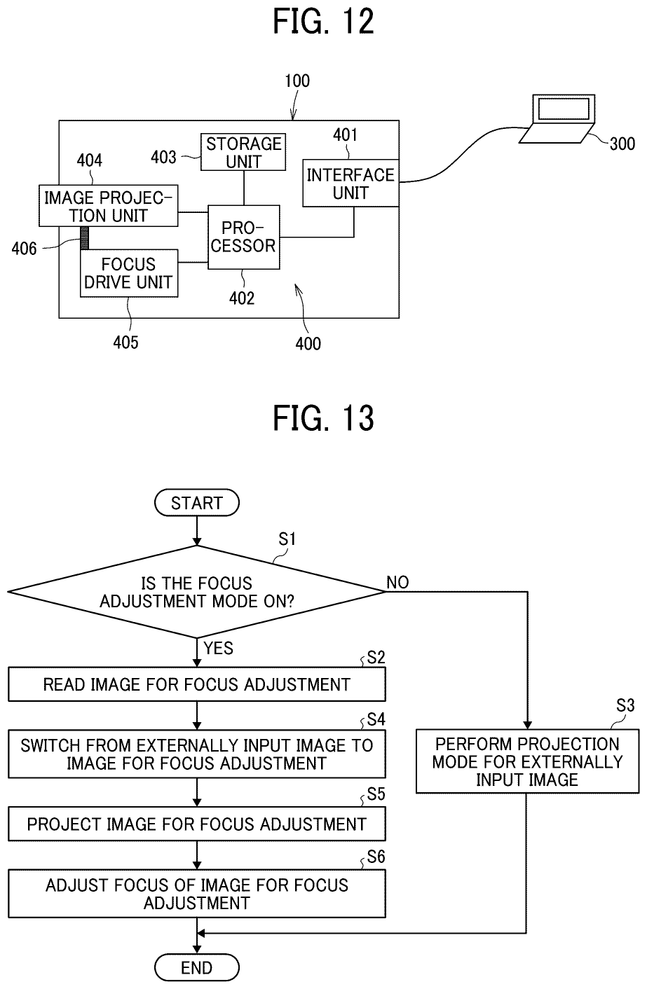

FIG. 12 is a schematic diagram illustrating an example of a focus adjustment mechanism 400 (or a focus adjuster).

As illustrated in FIG. 12, the focus adjustment mechanism 400 includes an interface unit 401, a processor 402, a storage unit 403, an image projection unit 404, and a focus drive unit 405.

The interface unit 401 acquires information output from an information processing device 300 such as a personal computer that outputs image information or a memory that stores image information. The processor 402 processes image information input from the interface unit 401. The storage unit 403 stores image information for focus adjustment. The image information for focus adjustment is information on the third image light C having the focal position c between the two focal positions a and b to be adjusted, or the evaluation chart included in the third image light C. The image projection unit 404 generates and projects image light based on image information input from the processor 402, and includes, for example, the image light generator 2 and the projection optical system 3 illustrated in FIG. 2.

The focus drive unit 405 moves one or some, or all of the multiple lenses included in the projection optical system 3 of the image projection unit 404 in the axial direction of projection light. This aligns the focus of image light for focus adjustment (third image light C) with the projection plane P at a desirable projection position on the projection plane P or positions the first image light A and the second image light B for focus adjustment so that the projection plane P is between the first image light A and the second image light B. In the example of FIG. 12, the focus drive unit 405 and the lens or lenses of the projection optical system 3 are coupled via a focus coupling unit 406; however, the focus drive unit 405 may be included in the image projection unit 404.

Since the image projection apparatus 100 includes the focus adjustment mechanism 400 as described above, the focal position can be easily adjusted. The adjustment of the focal position by the focus adjustment mechanism 400 may be performed automatically or manually. In the case of manual adjustment, the focus drive unit 405 is not used, and a unit of detecting that an adjustment operation of the focal position is to be performed, a unit of detecting that an adjustment operation of the focal position has been performed, or the like may be provided. Alternatively, a unit of detecting whether a focus adjustment mode has been selected may be used as the unit of detecting the above-described situations. When the focal position is automatically adjusted, in response to detecting the selection of the focus adjustment mode, image light for focus adjustment is projected from the image projection unit 404 based on image information stored in the storage unit 403.

### Adjustment Flow of Focal Position

FIG. 13 is a flowchart presenting an example of focal position adjustment performed by the focus adjustment mechanism 400.

As present in FIG. 13, in step S1, the processor 402 determines whether the focus adjustment mode is on. When it is detected that the focus adjustment mode is on in step S1 (step S1, YES), in step S2, information on image light to be projected during focus adjustment is read from the storage unit 403 to the processor 402. The situation in which the focus adjustment mode is on can be confirmed, for example, when the user starts a focus adjustment operation using a remote controller or the like and a detecting unit detects a signal that is emitted from the remote controller or the image projection apparatus. When the image information for focus adjustment is read by the processor 402, in step S4, the processor 402 switches image information input until then from the information processing device 300 to the image information for focus adjustment. In step S5, the image projection unit 404 generates image light based on the image information for focus adjustment input from the processor 402 and projects the image light. Thus, in step S6, an image for focus adjustment is projected on the projection plane. The user or the like adjusts the focal position so that the focus of the image is aligned with the projection plane while visually checking the projected image.

In contrast, when it is not detected that the image adjustment mode is on in step S1 (step S1, NO), in step S3, image information from the information processing device 300 is read by the processor 402, and the projection mode based on the image information (externally input image) is performed.

As described above, when it is detected that the image adjustment mode is on, the focal position is adjusted based on the image for focus adjustment. Hence the focal positions a and b of the first image light and the second image light having the different magnitudes of light energies can be adjusted to be located on the sides opposite to each other with respect to the projection plane P. Since the user can adjust the focal position based on the image for focus adjustment automatically projected on the projection plane, the focal position can be easily adjusted. Additionally or alternatively to the manual focal position adjustment that is manually performed by the user or the like while the user visually checks the image for focus adjustment projected on the projection plane, automatic focal position adjustment may be performed by capturing a projected image and optimizing the contrast.

### Example of Image for Focus Adjustment

Images for focus adjustment to be used when a user performs focus adjustment of the image projection apparatus or when an assembly operator performs focus adjustment of the image projection apparatus in a manufacturing process are described with reference to FIGS. 17 to 20C.

FIG. 17 is a view illustrating an example arrangement of evaluation charts included in an image for focus adjustment. In the example of FIG. 17, a projection plane P is divided into nine areas u1 to u9 in an equal matrix form.

In the manufacturing process of the image projection apparatus, to keep desirable quality of projection images, in general, many evaluation charts of an image for focus adjustment are projected on a projection plane to adjust the focal position in the entire area of the projection plane. Thus, for example, it is desirable to project an evaluation chart at each of centers o1 to o9 of the divided nine areas u1 to u9 in FIG. 17, to perform assembly adjustment for the components so that each evaluation chart is in focus, and to perform an inspection process.

In contrast, when the user performs focus adjustment of the image projection apparatus, if many evaluation charts are projected on the projection plane P, the user may be confused about which evaluation chart is to be targeted and adjusted. As long as the image projection apparatus has been adjusted to have certain quality in the manufacturing process, when the user performs the focus adjustment, the user does not necessarily perform the focus adjustment operation to the same extent as in the manufacturing process. Rather, when the user performs the focus adjustment, the focus adjustment operation is desirably as simple as possible, and the image for focus adjustment to be projected is desirably as simple as possible.

Thus, when the user performs the focus adjustment, instead of projecting the evaluation charts at all the centers o1 to o9 of the nine areas u1 to u9 as in the manufacturing process, for example, as in the example in FIG. 17, it is desirable to project evaluation charts 90 at a total of five positions of the center o5 and vicinities of four corners c1 to c4 of the projection plane P. As described above, by projecting the evaluation charts 90 at the center o5 and in the vicinities of the four corners c1 to c4 of the projection plane P, resolution at the center and the periphery of the projection plane P can be ensured, and certain quality of projection images can be ensured. Since the evaluation charts 90 are projected at the five positions, the user minimally moves the viewpoint, thereby providing the image projection apparatus that is easily handled by the user. Since the total area of the evaluation charts 90 can be minimized, when the APL of the background portion without the evaluation chart 90 is determined, the evaluation chart 90 does not necessarily have the determined value of APL, and thus the difference between the determined value of APL and the actual value of APL including the multiple evaluation charts 90 can be decreased. Thus, it is most desirable to set the projection positions of the evaluation charts 90 at about five positions at the center and in the periphery of the projection plane P.

Specifically, it is desirable to arrange the evaluation charts 90 at the center o5 of the projection plane P, and at positions in the vicinities of the corners c1 to c4 on four straight lines connecting the center o5 and the four corners c1 to c4. More specifically, it is desirable to arrange the evaluation charts 90 at, in addition to the center o5 of the projection plane P, the centers o1, o3, o7, and o9 of the areas u1, u3, u7, and u9 including the four corners c1 to c4 of the projection plane P; positions e1, e3, e7, and e9 between the centers o1, o3, o7, and o9 and the four corners c1 to c4; or the four corners c1 to c4. Alternatively, the evaluation charts 90 projected in the vicinities of the four corners c1 to c4 may be arranged at positions between the centers o1, o3, o7, and o9 of the areas u1, u3, u7, and u9 including the four corners c1 to c4, and the positions e1, e3, e7, and e9 near the corners c1 to c4 (positions illustrated in FIG. 17).

As described above, by selecting the center o5 and the positions in the vicinities of the four corners c1 to c4 (the positions between the centers o1, o3, o7, and o9 of the areas u1, u3, u7, and u9 including the four corners c1 to c4, and the corners c1 to c4) of the projection plane P as the projection positions of the evaluation charts 90, focus adjustment can be performed while viewing the balance of the projection image at the position of the center o5 at which the quality of projection images is most apparent and in the vicinities of the four corners c1 to c4 at which focus adjustment is most difficult.

When the user performs the focus adjustment, it is desirable to set in advance a simple mode different from the mode of the focus adjustment in the manufacturing process so that the user can select a mode of projecting the evaluation charts at the above-described five positions. The user may want to perform the focus adjustment more specifically. In such a case, multiple specific modes in which evaluation charts can be projected at more than five positions may be set so that a desirable mode can be selected in accordance with the purpose of use of the image projection apparatus. A person in charge of installation or service of the image projection apparatus may perform the focus adjustment. In such a case, an image for focus adjustment in a service mode may be prepared in which evaluation charts can be projected at more than five positions.

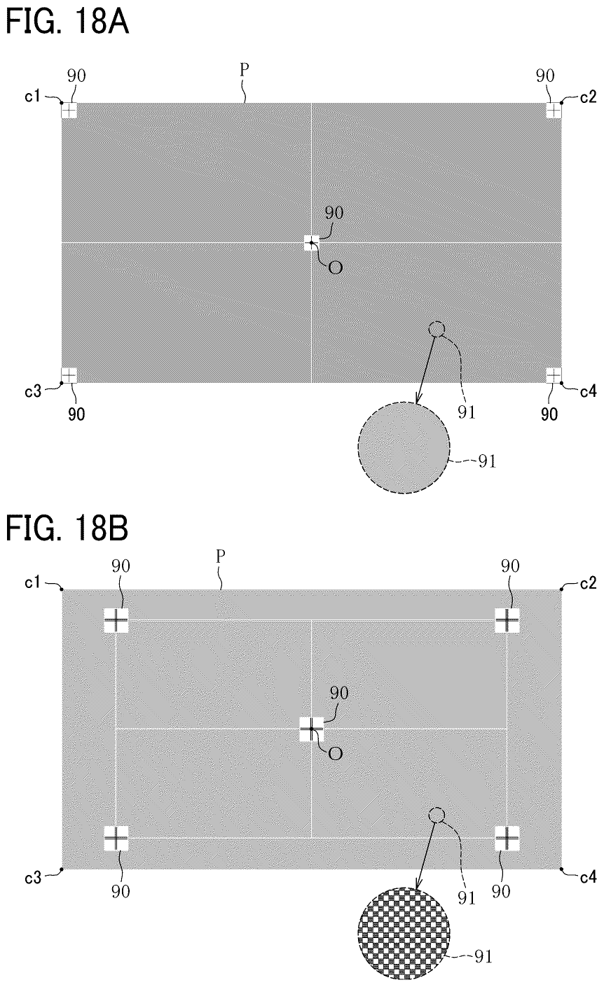

FIG. 18A and FIG. 18B are views illustrating other examples of an image for focus adjustment.

In the example of FIG. 18A, evaluation charts 90 of an image for focus adjustment each are displayed as a black cross of single lines (vertical and lateral single-line cross shape) on a white background. In this case, the evaluation charts 90 are projected at five positions of a center O and four corners c1 to c4 of a projection plane P. A background portion 91 of the image for focus adjustment other than the evaluation charts 90 has a pattern in which the APL is adjusted to a desirable value of, for example, 50%. That is, the background portion 91 is a halftone image in which gradation is selected so that the brightness of the output image has an intensity of 50% with respect to white. Specifically, for 256 gradations when γ=2.2 (described later), as long as the gradation value is appropriately determined (for example, about 186), the output value is about 50%, and an image corresponding to the APL of 50% is obtained.

In the example of FIG. 18B, evaluation charts 90 each are displayed as a black cross of double lines (vertical and lateral double-line cross shape) on a white background. A background portion 91 of the image for focus adjustment other than the evaluation charts 90 has a pattern in which the APL is adjusted to a desirable value of, for example, 50%. In FIG. 18B, the background portion 91 is displayed apparently in gray; however, when the background portion 91 is enlarged in units of pixels (see an enlarged view in FIG. 18B), white pixels and black pixels are alternately projected. That is, in this case, one of binary values of all white and all black is projected on a pixel basis at a ratio of 1:1. The APL is determined by the ratio of the number of white pixels to the number of black pixels.

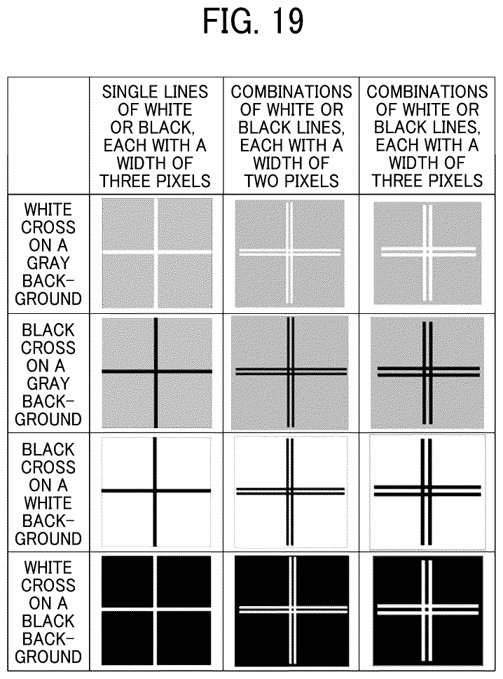

FIG. 19 is a table presenting other examples of an evaluation chart.

Examples of the evaluation chart presented in FIG. 19 are various examples of the evaluation chart particularly when the user performs the focus adjustment (simple mode). As presented in FIG. 19, many combinations can be selected, such as setting the color of the cross portion of the evaluation chart to white or black, forming the cross portion with single lines or plural lines, and setting the color of the background portion of the evaluation chart to black or white.

To facilitate handling when the user performs the focus adjustment, the width of the line of the evaluation chart, that is, the number corresponding to the number of pixels, is desirably larger than the unit of pixels of the image modulation element (resolution is coarser). When the width of the line of the evaluation chart is set to be equal to the unit of pixels (resolution) of the image modulation element, the sensitivity of focusing increases, and it is difficult for the user to perform adjustment. Thus, it is desirable to use a pair of black or white continuous lines. As described above, by setting the width of the line of the evaluation chart to twice or three times the panel resolution, the user can easily perform the focus adjustment. When the assembly operator in the manufacturing process or the person in charge of service performs the focus adjustment, the width of the line of the evaluation chart does not have to be set as described above. An evaluation chart including lines or characters expressed in the unit of pixels of the image modulation element is suitably used.

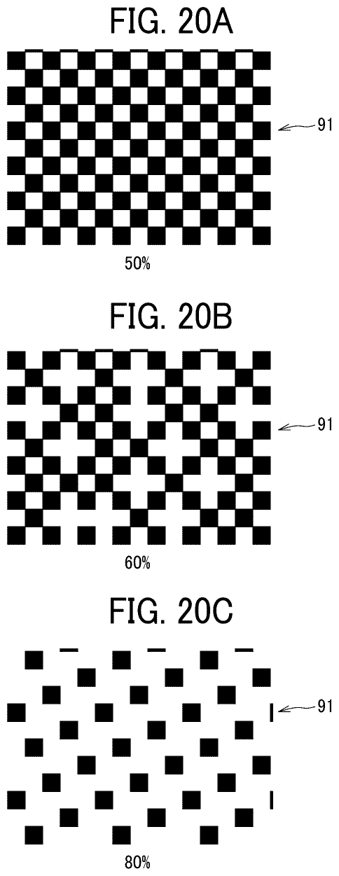

FIG. 20A, FIG. 20B, and FIG. 20C are views illustrating other examples of a background portion of an image for focus adjustment.

FIG. 20A illustrates an example of a background portion 91 having an APL of 50%. FIG. 20B illustrates an example of a background portion 91 having an APL of 60%. FIG. 20C illustrates an example of a background portion 91 having an APL of 80%. As described above, since each pixel is a white pixel or a black pixel, the APL can be accurately determined. In the case of gray display, the APL depends on the performance of gradation reproducibility, and hence the APL is not accurately determined. This is because multiple y curves can be selected. For example, in a case of an image projection apparatus that can display an image in 256 gradations from 0 of black to 255 of white, the brightness information of the input signal and the display gradation value are not linear in many cases. Insteas, an exponential function that is convex downward is often used. The function includes multiple variations (the function is referred to as a γ curve). When the relationship between an input value x and an output value y in the γ curve is expressed by y=x^{γ}, the exponent represents the value of γ. The value of γ typically takes a value of γ=2, γ=0, or a value around γ=2.2. In many cases, an image projection apparatus includes many image expression modes, and even when a gradation value is selected to display 50% gray, the gradation value changes depending on the value of γ, and hence an accurate APL is not determined. A method of determining the APL that does not depend on such γ is to determine the APL by the ratio of the numbers of black or white pixels. Thus, a background image having an accurate APL can be obtained.

While the image for focus adjustment and the evaluation chart when the focus adjustment is performed have been described above with reference to FIGS. 17 to 20C, the image for focus adjustment may be projected based on image information stored in advance in the image projection apparatus, or may be projected based on image information input from an external device to the image projection apparatus.

The image projection apparatus according to the disclosure is not limited to the above-described embodiments.

For example, the disclosure is applicable to, other than an image projection apparatus that projects image light on a flat plane such as a screen, an image projection apparatus that projects image light on a three-dimensional structure such as a car body or a building.

Thus, according to any of the embodiments of the disclosure, the focal positions a and b of the first image light and the second image light to be adjusted are not necessarily adjusted with the entire projection plane P interposed. For example, when the projection plane is a plane having protrusions and depressions and when the distance from the image projection apparatus to the projection plane largely varies depending on the portion of the projection plane, the position of at least a portion of the projection plane may be adjusted to be located between the focal positions a and b of the first image light and the second image light.

The image projection apparatus according to any of the embodiments of the disclosure can be used in various situations including commercial use (e.g. projection displays for business, meetings, and presentations), home use, medical use (e.g., projection displays for monochrome medical images such as X-ray images and magnetic resonance imaging (MRI) scans), public use (e.g., projection displays for various information, advertisements, and signage in public places, shops, and transportation facilities), or industrial use (e.g., a projection apparatus installed in a factory). The image projection apparatus according to any of the embodiments of the disclosure may have a projection mode (a color mode, a moving image mode, an image mode, a medical mode for projecting medical images, a public mode for projecting information or signage outdoors or in shops) corresponding to each purpose of use, and control on the driving method and driving amount of, for example, a light source, power, cooling, or output may be automatically changed in accordance with a change in mode.

To summarize the aspects of the present disclosure, the present disclosure includes at least the following aspects.

### Aspect 1

According to Aspect 1, an image projection apparatus includes a light source; an image light generator to receive light emitted from the light source and generate image light; and a projection optical system to project the image light generated by the image light generator on a projection plane. The image light to be projected on the projection plane from the projection optical system includes first image light having a predetermined light energy, and second image light having a light energy larger than the light energy of the first image light. A focal position in a case where the first image light is projected and a focal position in a case where the second image light is projected are arranged with at least a portion of the projection plane interposed.

### Aspect 2

According to Aspect 2, in the image projection apparatus of Aspect 1, the focal positions arranged with at least the portion of the projection plane interposed include focal positions in a case where changes in the focal positions have become stable states after the first image light and the second image light start being projected.

### Aspect 3

According to Aspect 3, in the image projection apparatus of Aspect 1, the focal positions arranged with at least the portion of the projection plane interposed include focal positions in a case where a change in temperature of the projection optical system has become a stable state after the first image light and the second image light start being projected.

### Aspect 4

According to Aspect 4, in the image projection apparatus of Aspect 1, the focal positions arranged with at least the portion of the projection plane interposed include focal positions in a case where changes in the focal positions have become maximum after the first image light and the second image light start being projected.

### Aspect 5

According to Aspect 5, in the image projection apparatus of any one of Aspect 1 to Aspect 4, a relationship of L/3≤La, Lb≤2L/3 is satisfied, where L is a distance between the focal positions arranged with at least the portion of the projection plane interposed, La is a distance between the focal position in the case where the first image light is projected and the projection plane, and Lb is a distance between the focal position in the case where the second image light is projected and the projection plane.

### Aspect 6

According to Aspect 6, in the image projection apparatus of any one of Aspect 1 to Aspect 5, the first image light has an average picture level smaller than an average picture level of the second image light.

### Aspect 7

According to Aspect 7, in the image projection apparatus of any one of Aspect 1 to Aspect 6, the first image light includes monochrome image light having an area ratio of white image light smaller than an area ratio of white image light of the second image light.

### Aspect 8

According to Aspect 8, in the image projection apparatus of any one of Aspect 1 to Aspect 7, the first image light includes image light having a light energy smaller than 50% of light having a maximum energy that the light source emits. The second image light includes image light having a light energy larger than 50% of the light having the maximum energy.

### Aspect 9

According to Aspect 9, in the image projection apparatus of any one of Aspect 1 to Aspect 8, the first image light includes image light in which an image of a black background includes an evaluation chart for evaluating image quality or the focal position in an emission mode of darkest light that the light source emits. The second image light includes image light in which an image of a white background includes an evaluation chart for evaluating image quality or the focal position in an output mode of brightest light that the light source outputs.

### Aspect 10

According to Aspect 10, in the image projection apparatus of any one of Aspect 1 to Aspect 9, the light energy of the first image light is 1/10 or less of the light energy of the second image light.

### Aspect 11

According to Aspect 11, in the image projection apparatus of any one of Aspect 1 to Aspect 10, the image projection apparatus projects third image light having a focal position between the focal positions arranged with at least the portion of the projection plane interposed.

### Aspect 12

According to Aspect 12, in the image projection apparatus of Aspect 11, the third image light includes image light including an evaluation chart for evaluating image quality or the focal position.

### Aspect 13

According to Aspect 13, the image projection apparatus of Aspect 11 or Aspect 12 further includes a focus adjustment mechanism to move a lens included in the projection optical system when the third image light is projected.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image projection apparatus comprising:
a light source;
an image light generator to receive light emitted from the light source and generate image light;
a projection optical system to project the image light generated by the image light generator, onto a projection plane; and
an optical component in the projection optical system,
wherein the projection optical system projects:
first image light having a first light energy onto a first focal position; and
second image light having a second light energy larger than the first light energy of the first image light onto a second focal position, and
the projection plane is between the first focal position and the second focal position.

2. The image projection apparatus according to claim 1, further comprising circuitry configured to move the optical component so that the projection plane is between the first focal position and the second focal position.

3. The image projection apparatus according to claim 1,
wherein the circuitry respectively adjusts the first focal position and the second focal position to a stabilized first focal position and a stabilized second focal position, and
the stabilized first focal position and the stabilized second focal position are positions where changes in the first focal position and the second focal position are stabilized after the projection optical system starts projecting the first image light and the second image light on the projection plane.

4. The image projection apparatus according to claim 1,
wherein the circuitry respectively adjusts the first focal position and the second focal position to a stabilized first focal position and a stabilized second focal position, and
the stabilized first focal position and the stabilized second focal position are positions where a temperature change in the projection optical system is stabilized after the projection optical system starts projecting the first image light and the second image light on the projection plane.

5. The image projection apparatus according to claim 1,
wherein the circuitry respectively adjusts the first focal position and the second focal position to a maximized first focal position and a maximized second focal position where changes in the first focal position and the second focal position are maximized after the projection optical system starts projecting the first image light and the second image light on the projection plane.

6. The image projection apparatus according to claim 1,
wherein a relationship of L/3≤La, Lb≤2L/3 is satisfied,
where L is a distance between the first focal position and the second focal position,
La is a distance between the first focal position and the projection plane, and
Lb is a distance between the second focal position and the projection plane.

7. The image projection apparatus according to claim 1,
wherein the first image light has an average picture level smaller than an average picture level of the second image light.

8. The image projection apparatus according to claim 1,
wherein the first image light includes monochrome image light having an area ratio of white image light smaller than an area ratio of white image light of the second image light.

9. The image projection apparatus according to claim 1,
wherein the first image light has a light energy smaller than 50% of light having a maximum energy that the light source emits, and
the second image light has a light energy larger than 50% of the light having the maximum energy.

10. The image projection apparatus according to claim 1,
wherein the first image light includes image light in which an image of a black background includes an evaluation chart for evaluating image quality or a focal position in an emission mode of darkest light that the light source emits, and
the second image light includes image light in which an image of a white background includes an evaluation chart for evaluating image quality or a focal position in an output mode of brightest light that the light source outputs.

11. The image projection apparatus according to claim 1,
wherein the first light energy of the first image light is 1/10 or less of the second light energy of the second image light.

12. The image projection apparatus according to claim 1,
wherein the projection optical system projects third image light having a third focal position between the first focal position and the second focal.

13. The image projection apparatus according to claim 12,
wherein the third focal position is on the projection plane.

14. The image projection apparatus according to claim 11, wherein the third image light includes image light including an evaluation chart for evaluating image quality or a focal position.

15. The image projection apparatus according to claim 12, further comprising a focus adjuster to move a lens in the projection optical system to project the third image light.
